(19) United States
(12) Patent Application Publication
(10) Pub. No.: US 2007/0166225 A1
(43) Pub. Date: Jul. 19, 2007

(54) Method for producing products from source materials by leaching with functional electrolytic water

(75) Inventors: Dennis W. Johnson, Simpsonville, SC (US); Mark S. Ehrnschwender, Terrace Park, OH (US); Ishwinder Grewal, Surrey (CA)

Correspondence Address: WOOD, HERRON & EVANS, LLP, 2700 CAREW TOWER, 441 VINE STREET, CINCINNATI, OH, 45202, US

(73) Assignee: Xcentia Energy LLC, Terrace Park, OH (US)

(21) Appl. No.: 11/334,924

(22) Filed: Jan. 19, 2006

(51) Int. Cl. B01F 1/00

(52) U.S. Cl. 423/658.5

(57) ABSTRACT

The present invention relates to methods for leaching products from source materials, especially combustion products from fuels including coal, bitumen, coke, oil, and other fuels that produce an ash such as flyash, bottom ash, etc. that have valuable components including minerals, precious and other metals, compounds, and the like using functional electrolytic water. The methods may produce other products, some of which are used in a process integrated into the pollution control equipment of a power plant.

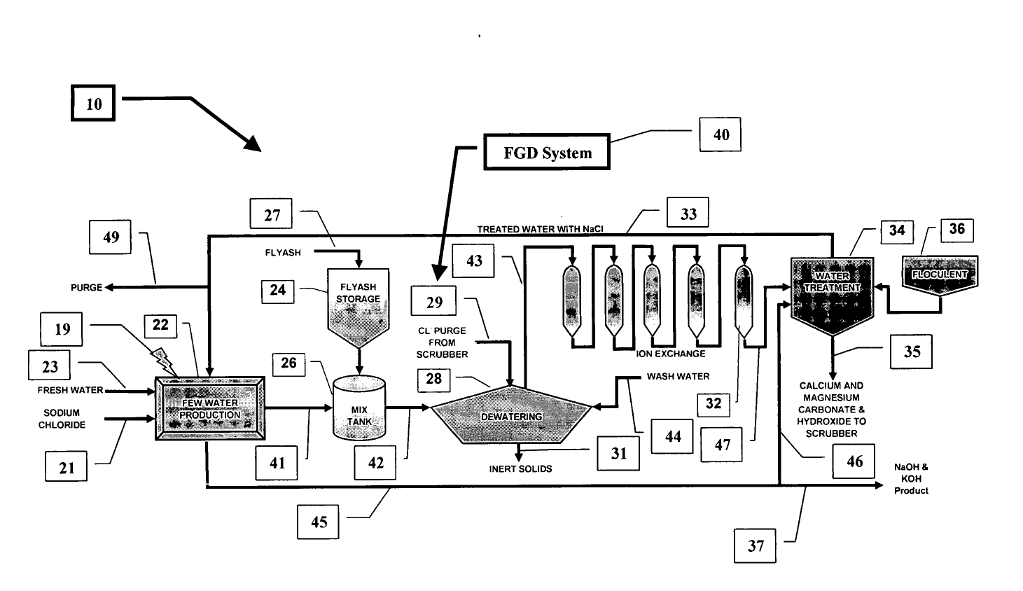

### FIELD OF THE INVENTION

The present invention relates to methods for leaching products from source materials such as ores, coal, and mineral deposits and, in particular, combustion products (CPs) from fuels that produce an ash.

### BACKGROUND OF THE INVENTION

Lixiviants are used in the mining industry, for example, for leaching and mineral recovery. A lixiviant is a liquid medium that selectively extracts the desired metal from the ore or material to be leached rapidly and completely, and from which the desired metal can then be recovered in a concentrated form. Conventional lixiviants, including acids such as hydrochloric acid, aqua regia (three parts hydrochloric (HCl) and one part nitric (HNO₃) acid), and cyanides, may be used for leaching products or elements from ore, waste, coal, earth or water. Lixiviant-based processes may be used for extracting products, such as precious metals, base metals or other elements, from a source material and in other applications, such as removing toxic substances from the source material. Conventional lixiviant-based processes comprise contacting source material with the lixiviant (i.e., an aqueous leaching solution containing a leaching agent such as compounds of bromine and chlorine and/or other halide compounds, thereby producing an aqueous leachate containing the products to be recovered from the source material.

The art of leaching and recovering metals using conventional means is well established. It is also known to use oxidation in combination with leaching. For example, U.S. Pat. No. 5,529,606 to Hewlett, et al. teaches a method of oxidizing particles in which, after oxidation, leaching agents including bromide and chlorine compounds are added to the mixture to leach the metals in soluble salts from the particles.

Conventional leachates or leaching solutions may be hazardous to the environment and present risks to worker health. Moreover, conventional leaching solutions produce hazardous wastes that must be handled carefully, neutralized, decontaminated and the like in order to produce an environmentally safe material. Significant amounts of waste material are produced when the metals are extracted.

Functional electrolytic water (FEW) is a recently developed lixiviant that may also be used for leaching products or elements from ore, waste, coal, earth or water. The use of FEW in source material processing is described, for example, by Runyon in United States Patent Application 20040244537, the disclosure of which is hereby incorporated by reference herein in its entirety. FEW has been tested and used on a limited basis for ore and mineral processing and has certain advantages for this application. One aspect of FEW is that it can be produced by methods that result in both a basic and acidic medium. The properties of the basic and acidic solutions may be integrated into the process to facilitate leaching and production of other products. Another aspect of the reductive FEW medium is that it can be used in either vat-leaching or heap-leaching to initially reduce certain base materials to make certain base materials soluble in order to be able to leach any interstitial gold, silver, and other metals and elements with FEW acid oxidizing medium.

FEW generation is similar to the use of electrochemical cells for manufacturing chlorine and caustic soda in the chlor-alkali process. In the chlor-alkali process, NaCl salt, the primary raw material, is electrolytically split using direct current (DC) electricity, resulting in chlorine and an available sodium ion (Na⁺) that is reacted with water in the cell to make caustic soda. A diaphragm is often used in the chlor-alkali process to separate the co-products caustic soda and chlorine. In the FEW generator, the cation (sodium, for example) is similarly reacted with water, which is also electrolytically split, to form the hydroxide compound. The hydrogen ion, which is produced when water is electrolytically split, is separated to form the acidulous (i.e., slightly acidic) FEW leaching stream. Other processes, such as U.S. Pat. No. 5,246,551 to Pletcher, et al., teach methods for producing an alkali metal hydroxide without the simultaneous production of chlorine.

Combustion products (CPs) are produced from fuels, including coal, bitumen, coke, oil, and other fossil fuels. These combustions products produce an ash, such as flyash, bottom ash, etc., that contains valuable components, including minerals, precious and other metals and compounds. In particular, ashes, as well as slags, pyrite, etc., contain valuable metals, such as mercury, vanadium, nickel, chromium, cobalt, strontium, antimony, arsenic, cadmium, manganese, beryllium, cadmium, barium, molybdenum, titanium, zinc, strontium, copper, silver, boron, and even uranium and radium, in trace quantities and other semi-precious metals such as iron, lead, and aluminum in significant quantities, as suggested by the following table (Source: 40th Edition of Steam, Its Generation and Use):

Ash Content and Ash Fusion Temperatures of Some U.S. Coals and Lignite

| | Low Volatile | | | | | Sub- | |
|---|---|---|---|---|---|---|---|
| Rank: | Bituminous | High Volatile Bituminous | | | | bituminous | Lignite |
| Seam | Pocahontas No. 3 | No. 9 | No. 6 | Pittsburgh | | Antelope | |
| Location | West Virginia | Ohio | Illinois | West Virginia | Utah | Wyoming | Texas |
| Ash, dry basis, % | 12.3 | 14.1 | 17.4 | 10.9 | 17.1 | 6.6 | 12.8 |
| Sulfur, dry basis, % | 0.7 | 3.3 | 4.2 | 3.5 | 0.8 | 0.4 | 1.1 |
| Analysis of ash, % by wt | | | | | | | |
| SiO₂ | 60.0 | 47.3 | 47.5 | 37.6 | 61.1 | 28.6 | 41.8 |
| Al₂O₃ | 30.0 | 23.0 | 17.9 | 20.1 | 21.6 | 11.7 | 13.6 |
| TiO₂ | 1.6 | 1.0 | 0.8 | 0.8 | 1.1 | 0.9 | 1.5 |
| Fe₂O₃ | 4.0 | 22.8 | 20.1 | 29.3 | 4.6 | 6.9 | 6.6 |
| CaO | 0.6 | 1.3 | 5.8 | 4.3 | 4.6 | 27.4 | 17.6 |
| MgO | 0.6 | 0.9 | 1.0 | 1.3 | 1.0 | 4.5 | 2.5 |
| Na₂O | 0.5 | 0.3 | 0.4 | 0.8 | 1.0 | 2.7 | 0.6 |
| K₂O | 1.5 | 2.0 | 1.8 | 1.6 | 1.2 | 0.5 | 0.1 |
| SO₃ | 1.1 | 1.2 | 4.6 | 4.0 | 2.9 | 14.2 | 14.6 |
| P₂O₅ | 0.1 | 0.2 | 0.1 | 0.2 | 0.4 | 2.3 | 0.1 |

Ashes also contain chemically inert species such as silica, which are of little or no value in their native state, and calcium, magnesium, sodium, and potassium. These latter species have value as alkalis if converted to a commercially viable form, such as oxides, carbonates, hydroxides, etc., and provided they are not contaminated. Some species, such as calcium, magnesium, sodium, and potassium, found in ashes will tend to react with acids, which limits the effectiveness of acid leaching.

What is needed, therefore, is an improved method for leaching products, such as minerals and metals, from ore, waste, coal, earth, ashes, and other appropriate source materials.

### SUMMARY

In one aspect of the present invention, a leaching method includes generating an aqueous leaching solution, contacting the aqueous leaching solution with a source material to form a mixture, and removing products from the aqueous leaching solution and source material mixture. The method further comprises producing an alkali stream while generating the aqueous leaching solution. The resultant alkali stream may be used to create usable products from less valuable materials in the source material including, but not limited to, potassium, magnesium, calcium, and sodium. This alkali stream containing recovered potassium, magnesium, calcium, and/or sodium may be sold as a product, used for water treatment, or used as a reagent in a separate process, such as an acid gas scrubber.

In one embodiment of the present invention, the leaching solution may include a functional electrolytic water (FEW) medium for the leaching of elements from ores, ore concentrates, waste, coal, earth, or water, which has been demonstrated for a very wide range of metals and elements. An aspect of the present invention is that the FEW medium includes both an oxidizing and reducing (basic or acidic) stream, whereby; either alkaline or acidic source materials can be leached at the natural pH range of the source material, thereby conserving lixiviant in neutralizing certain source materials before leaching.

An alternative embodiment of the present invention utilizes the FEW oxidizing medium for pre-oxidation (before leaching) of source materials by either vat-leaching or heap-leaching. After the oxidation phase, the lixiviant is formed for the final leaching.

The use of FEW eliminates the hazards and risks associated with conventional leachates. FEW does not require careful handling, neutralization, decontamination and the like. Metals and other products may be extracted from the source material without generating significant amounts of waste material. Using FEW, according to this invention there is less waste produced. This invention especially reduces hazardous waste otherwise produced by prior art leaching methods.

In the present invention, FEW is generated or produced for use as an aqueous leaching solution with a membrane type generator and is used to leach valuable materials from source materials, especially the ashes of combustion products (CPs). The base material for the generation or production of FEW is a chloride- or bromide-containing salt, such as sodium chloride or potassium chloride, that is either purchased, recovered from the process, or obtained as a byproduct from flue gas desulfurization (FGD). If FEW is generated with a chloride-containing salt, the chloride-containing salt is split into a chloride- and/or chlorine-containing acidic stream in the FEW generator and a hydroxide solution containing the cation of the salt. The product stream from the FEW generator may contain both chlorine and chloride produced from the chloride-containing salt or, if an alkali bromide is used as a base material, then the product stream may contain bromine and bromide. Alternatively, other ions may be used to form FEW. The acidulous FEW is used in the leaching process, while the hydroxide compounds become a product or, alternatively, are used to recover calcium and/or magnesium from the process. The calcium and magnesium are available for use in the FGD system as recycled material or may be used for water treatment or otherwise commercially sold.

The invention may also include the optional step of processing the ashes to remove and recover carbon. Separation and classification equipment is used to separate carbon, also referred to as unburnt carbon, which has properties significantly different from the rest of the ashes such that a carbon rich stream that can be returned to the combustion source.

### BRIEF DESCRIPTION OF THE DRAWING

The accompanying drawing, which is incorporated in and constitutes a part of this specification, illustrates embodiments of the invention and, together with a general description of the invention given above, and the detailed description given below, serves to explain the principles of the invention.

The FIGURE is a schematic representation of an arrangement with an FEW generation system incorporated to produce desirable products in accordance with the principles of the present invention.

### DETAILED DESCRIPTION

With reference to the FIGURE, a functional electrolytic water (FEW) leaching process 10 relies on an electrochemical FEW generator 22 that provides a leaching solution or leachate for separating and recovering valuable constituents from ash or other source materials and potential integration with a flue gas desulfurization (FGD) scrubber/pollution control technology that would be used at a fossil fuel fired power generating facility or other industrial plant.

The input into the electro-chemical FEW generator 22, which may operate either with or without membranes, is initially water 23, electrolytes and/or chemical reagents 21 (for example, sodium chloride, potassium chloride, sodium or potassium bromides, etc., and combinations of these substances), and power 19. Power 19 is used to electrolyze the water 23 with the added electrolytes and/or chemical reagents 21. The output of the FEW generator 22 is two streams used in the FEW leaching process 10, acidic FEW 41 and alkali FEW 45. The FEW generator 22 may be a membrane unit, in which the membranes are used to facilitate the separation of ions in addition to producing FEW, that produces both acidic FEW 41 and alkali FEW 45. In one embodiment of the present invention, the acidic FEW 41 may be used in the process for leaching valuable materials from the ash of combustion products and the alkali FEW 45 is used for water treatment.

In an alternative embodiment of the present invention, the FEW generator 22 may be an acidulous FEW generator produces only a super oxidizing water medium, but at a faster rate than a membrane-based FEW generator 22. The acidulous FEW generator operates without membranes and uses added electrolytes and/or chemical reagents to produce only an acidulous (slightly acidic) electrolyzed water. The acidulous FEW generator would generally be used only for source materials with little or no alkalinity.

The relative proportion of the acidic FEW 41 to alkali FEW 45 produced by the FEW generator 22 is a function of the following:
1) pH
2) ORP
3) Degree of electronic activity
4) Current density/intensity
5) Composition and concentration of the electrolyte(s)
6) Chemical reagents.

The aqueous leaching solution is acidic FEW 41 generated from sodium chloride, sodium bromide, potassium chloride, potassium bromide, or combinations thereof. In one embodiment, the acidic FEW 41 is generated by the FEW generator 22 from sodium and/or potassium chloride and is directed to a mix tank 26. In the mix tank 26, source material 27, such as combustion products like flyash, are taken from source material storage vessel 24 and blended with the acidic FEW 41. The mix tank 26 may be replaced by a series of tanks, heap leaching, or any of several known methods for mixing a solid with a water, leachate, lixiviant, etc. with sufficient mixing, residence time, and flow to allow the recovery of some or all of the desired constituents. In some cases, it may be required to further adjust the pH or to add other lixiviants and/or oxidants to the acidic FEW 41 before the acidic FEW 41 enters the mix tank 26. For example, HCl may be added to the acidic FEW 41 from the FEW generator 22 to further reduce the pH and increase the ionic strength of the stream. In other cases, the source material 27 may be contacted with a pre-oxidizing medium before leaching and before forming the aqueous leaching solution.

A portion of the contents of the mixture of acidic FEW 41 and source material 27 in the mix tank 26 is removed continuously, or in a batch method, as stream 42 and sent to a dewatering system 28. The dewatering system 28 may consist of conventional methods understood by a person having ordinary skill in the art to separate the suspended solids, which will consist mostly of inert species such as carbon and silica and residual precious or semi-precious constituents, from the rich water stream. The dewatering devices employed may be chosen from a group consisting of thickeners, hydroclones or hydrocyclones, centrifuges (i.e. pusher, peeler, drum, horizontal, basket, decanter, etc.), vacuum dewatering (for example, drum or belt filters), pressure filtration, clarifiers, settling tanks or ponds, and other solid/liquid separation devices or systems.

In the one embodiment, a purge stream 29 from a flue gas desulfurization or FGD system 40 (also known as an SO₂ scrubber, absorber, or reactor), such as a calcium-based (lime or limestone) FGD system, may be introduced into the leaching process 10. An exemplary method of introducing the purge stream 29 from the FGD system 40 is to provide it to the dewatering system 28 of the leaching process 10. However, if the purge stream 29 contains valuable materials, it may be introduced into leaching process 10 in another appropriate location such as in mix tank 26.

The purge stream 29 may contain fine solids of FGD reaction products, inert material, ash, lime or limestone, and other suspended solids that can be separated in the dewatering system 28 from the liquid solution either directly or after combining with the contents of mix tank 16. The purge stream 29 from the FGD system 40 may also contain soluble species including chlorides, which may advantageously be used in the leaching process 10. Removal of chlorides from the FGD system 40 is advantageous because chlorides are known to promote or cause corrosion, reduce the effectiveness of SO₂ removal, and increase the density of the water stream. Removal of fine materials from the FGD system 40 is also advantageous because fines removal helps increase the purity of the final product and prevents the problems associated with the build up of inert fine materials in the FGD process.

The chlorides from the purge stream 29 may be recovered for use in the leaching process 10, while the inerts are combined with the inerts producing a dewatered product of inert solids 31 from the combination of source material leaching and purge stream fines. The inert solids 31 may be disposed of or, alternatively, further processed for sale. Wash water 44 may be used, if desired, to remove residual metals, chlorides, and other desirable soluble materials from the inert solids 31 prior to discharge from leaching process 10. The wash water 44 may be fresh water, a salt or brine solution, FEW, or the introduction of wash water 44 may comprise a combination of multiple washing steps using one or more wash solutions.

The rich or pregnant water stream 43 from the dewatering system 28 is sent to an ion exchange system 32 for separation of the precious or semi-precious constituents of the mixture of acidic FEW 41 and source material 27. In ion exchange system 32, selective resins may be used to separate the precious or semi-precious source constituents or products of the mixture, although activated carbon and other methods, including but not limited to precipitation, chemical reaction, purification, concentration, etc. can also be used. If resin separation is used, the pregnant water stream 43 is pumped through a column containing one or more selective resins. Depending on the nature of the pregnant solution and the species, which may be products or compounds of products, present in the solution, there may be numerous resin columns, each containing a different type of resin. For example, an SR3 resin could be used in a first column to retrieve gold from the pregnant water stream 43 and a second column containing DOWEX® M-4195 15 may be used to remove copper from the pregnant water stream 43. If it was desired to clean the final liquid discharge of all ions in solution, an AMBERLITE® 400 column may be used as a final catchall. Moreover, certain metals, such as mercury, may be separated for recovery using either a resin column or activated carbon solution.

Once a selective resin is loaded with the desired species, it is necessary to unload the products from the resin by methods understood by a person having ordinary skill in the art such as fuming, washing, chemical recovery methods, etc. The product unloading may be done at another location by sending the loaded resin to a processing facility. For example, the valuables may be removed from the selective resin by fuming, which is generally only economical when the recovered species has a high value, such as gold. With other valuables such as base metals, the cost of fuming the selective resin may be too high with respect to the value contained therein to prove economical. If fuming is not used, then the species may be unloaded from the selective resin using an appropriate solution.

A lean water stream 47 leaving ion exchange system 32, contains ions of products present in the base source material 27 that have not been captured in ion exchange system 32, but is otherwise depleted of the precious or semi-precious products. The products in lean water stream 47 include, but are not limited to, calcium, magnesium, sodium, potassium, and chloride. The lean water stream 47 is directed to a water treatment system 34. The water treatment system 34 may be a water softener system, many of which are known to a person having ordinary skill in the art, that contacts a water stream with a reagent in a process that promotes precipitation and separation of calcium and magnesium salts. The reagents are typically selected from a group of alkalis including lime [(Ca(OH)₂], soda ash (sodium carbonate, Na₂CO₃), caustic soda (sodium hydroxide, NaOH), or other hydroxide based reagents that elevate the pH of the solution causing precipitation of calcium and/or magnesium as hydroxides, carbonates, sulfates, bicarbonates, etc. The water softener systems normally use clarification or other settling techniques to separate the precipitants from the treated water. The water treatment system 34 may use sodium and potassium hydroxide produced in the FEW generator 22 and shown as alkali stream 46, which is a portion of the alkali FEW 45. The NaOH and/or KOH in solution in alkali stream 46 will increase the pH of the solution in water treatment system 34. As the pH is increased, calcium and/or magnesium will precipitate in the water treatment system 34 according to known reactions for accomplishing water softening briefly described above.

The reaction products of calcium and magnesium, generally compounds in the hydroxide form, will settle in the water treatment system 34. Flocculent 36 may be used to facilitate settling if necessary. Flocculents, which are chemicals (like ferric chloride, ferric sulfate, aluminum sulfate, some commercially available cationic, anionic, or nonionic polymers, and other coagulants) that cause the precipitated particles to coagulate or combine to form flocs (coagulated masses of particles in a liquid), are used in water treatment processes to promote settling and separation of the precipitants from the treated water. The settled alkali solids 35 may be collected and used in the FGD system 40 as reagents for removal of acid gases, such as SO₂. In the FGD system 40, the calcium may be converted to gypsum and the magnesium may be converted to magnesium sulfate, which is one method that calcium and magnesium are removed from the leaching process 10 in a beneficial manner. Advantageously, the amount of reagent required by the FGD is reduced by the calcium and magnesium recovered from the source material or ash. This benefits the leaching process 10 by providing a purge of the calcium and magnesium, which would otherwise build up so that a waste stream containing valuable materials and chloride ions would be created.

Alternatively, alkali solids 35 may be sold or used in the FGD system 40 or injected into combustion processes at various locations, such as in a coal fired power plant. Some locations that the alkali solids 25 may be used in a power plant includes the furnace, after the air heater, before the particulate collection device, or in the flue work upstream of the FGD system 40 to reduce SO₃ and other acid gases.

The water effluent 33 from water treatment system 34 may contain potassium and sodium originating from the source material, along with chloride not removed in the ion exchange system 32. Water effluent 33 is returned to FEW generator 22 for reuse in generating acidic FEW 41 and alkali, FEW 45. This, in combination with the introduction of chloride purge stream 29 from the FGD system 40, reduces the need for externally-supplied electrolytes and/or chemical reagents 21.

Another aspect of the present invention includes the optional step of processing the source material 27 (either before or immediately after the combustion products storage vessel 24) or inert solids 31 (following dewatering system 28) to remove and recover carbon. Separation and classification equipment (not shown) is used to separate carbon, sometimes referred to as unburnt carbon, which has properties significantly different from the rest of the ashes. The separated carbon rich stream from the separation and classification equipment may be collected and either returned to the combustion source or otherwise handled separately from the rest of the material.

If necessary, purge stream 49 may be used to discharge excess water effluent 33. However, excess sodium and potassium from the leaching process 10 may constitute a saleable product, as indicated by stream 37. Stream 37, which is a portion of the alkali FEW 45, is produced when alkali FEW 45 contains excess NaOH and/or KOH. The excess NaOH and/or KOH are removed as a solution from the alkali FEW 45 for sale as an alkali solution, or for further processing or purifying including concentrating, precipitation and/or crystallization to increase the value of the NaOH and/or KOH in stream 37.

While the present invention has been illustrated by a description of various preferred embodiments and while these embodiments have been described in considerable detail in order to describe the best mode of practicing the invention, it is not the intention of applicants to restrict or in any way limit the scope of the appended claims to such detail. Additional advantages and modifications within the spirit and scope of the invention will readily appear to those skilled in the art. The invention itself should only be defined by the appended claims, wherein we claim:

1. A method for leaching constituents from a source material comprising:
generating an acidic aqueous leaching solution;
contacting the acidic aqueous leaching solution with the source material to form a mixture;
removing at least one product from the acidic aqueous leaching solution and source material mixture; and
producing an alkali stream while generating the acidic aqueous leaching solution.

2. The method of claim 1 wherein the aqueous leaching solution comprises acidic functional electrolytic water.

3. The method of claim 1 further comprising:
adding a lixiviant, an oxidant, or a combination thereof to the acidic aqueous leaching solution.

4. The method of claim 1 further comprising:
adding HCl to the acidic aqueous leaching solution to adjust a pH of the aqueous leaching solution.

5. The method of claim 1 wherein the acidic aqueous leaching solution contains a chloride-containing salt, and further comprising:
adding the chloride-containing salt to water to form the acidic aqueous leaching solution.

6. The method of claim 1 wherein the chemical reagents used to generate the acidic aqueous leaching solution include sodium chloride, sodium bromide, potassium chloride, potassium bromide, or combinations thereof.

7. The method of claim 6 wherein the chemical reagents used to generate the acidic aqueous leaching solution include chemical reagents present in an effluent stream of a water treatment device.

8. The method of claim 1 wherein the generating the acidic aqueous leaching solution further comprises:
separating ions using a membrane.

9. The method of claim 1 wherein the alkali stream comprises an aqueous hydroxyl solution of sodium, potassium, or a mixture thereof.

10. The method of claim 9 wherein the at least one product comprises the aqueous hydroxyl solution.

11. The method of claim 1 wherein the source material comprises a combustion product.

12. The method of claim 11 wherein the combustion product is ash, bottom ash, flyash, slag, pyrites from fossil fuel combustion, or combinations thereof.

13. The method of claim I wherein the source material is contacted with the acidic aqueous leaching solution using equipment or methods selected from the group consisting of mix tanks, heap leaching, a series of tanks, and combinations thereof.

14. The method of claim 13 further comprising:
directing at least a portion of the at least one product to a dewatering device.

15. The method of claim 14 wherein the dewatering device is selected from the group consisting of thickeners, hydroclones, hydrocyclones, centrifuges, vacuum dewatering, pressure filtration, clarifiers, and combinations thereof.

16. The method of claim 14 further comprising:
washing a solid effluent of the dewatering device.

17. The method of claim 14 further comprising:
disposing of the solid effluent of the dewatering device.

18. The method of claim 17 further comprising:
separating carbon from the solid effluent of the dewatering device before disposal.

19. The method of claim 1 wherein the source material is contacted with a pre-oxidizing medium comprising:
contacting at least a portion of the source material with the pre-oxidizing medium before contacting the source material with the acidic aqueous leaching solution.

20. The method of claim 1 further comprising:
directing at least a portion of the at least one product to a separating device.

21. The method of claim 20 wherein the separating device is selected from the group consisting of ion exchange system, ion exchange resins, activated carbon, and precipitation.

22. The method of claim 21 further comprising:
recovering a constituent from the separating device.

23. The method of claim 22 wherein recovering the constituent further comprises:
fuming, unloading using solutions, or a combination thereof.

24. The method of claim 20 further comprising:
directing an effluent of the separating device to a water treatment device.

25. The method of claim 24 further comprising:
producing treated water in the water treatment device; and
purging at least a portion of the treated water.

26. The method of claim 24 wherein the water treatment device is a water softening device.

27. The method of claim 24 further comprising:
forming a precipitate in the water treatment device selected from the group consisting of a calcium precipitate, a magnesium precipitate, and a mixture thereof in the water treatment device; and
collecting the precipitate as a stream.

28. The method of claim 27 further comprising:
directing the precipitate to a flue gas desulfurization system.

29. The method of claim 27 further comprising:
adding a flocculent substance to promote collection of the precipitate.

30. The method of claim 27 further comprising:
directing the precipitate to a combustion process.

29. The method of claim 1 further comprising:
using at least a portion of the alkali stream in a water treatment device.

31. The method of claim 1 further comprising:
combining a purge stream from a flue gas desulfurization system with the acidic aqueous leaching solution or with the mixture of the acidic aqueous leaching solution and the source material.

32. The method of claim 1 further comprising:
separating carbon from the source material before contacting the acidic aqueous leaching solution with the source material.
